(19) United States
(12) Patent Application Publication
(10) Pub. No.: US 2026/0184192 A1
(43) Pub. Date: Jul. 2, 2026

(54) METHOD FOR A BRAKE CONTROLLER FOR OPERATING AN ELECTRIC DRIVE OF A TRAILER VEHICLE, COMPUTER PROGRAM AND/OR COMPUTER-READABLE MEDIUM, BRAKE CONTROLLER, TRAILER VEHICLE

(71) Applicant: ZF CV Systems Global GmbH, Bern (CH)

(72) Inventors: Steffen Gerlach, Hannover (DE); Norbert Witte, Lauenau (DE); Axel Stender, Hameln (DE); Mark Cuyx, Zemst (BE)

(21) Appl. No.: 19/542,567

(22) Filed: Feb. 17, 2026

Related U.S. Application Data
(63) Continuation of application No. PCT/EP2024/074396, filed on Sep. 2, 2024.

(30) Foreign Application Priority Data
Sep. 19, 2023 (DE) 10 2023 125 298.4

(51) Int. Cl. B60L 15/20

(52) U.S. Cl. CPC B60L 15/2009; B60L 2200/28; B60L 2240/12

(57) ABSTRACT

A method for a brake controller is for operating an electric drive of a trailer vehicle. The trailer vehicle has a drive controller for controlling the electric drive and is configured to be communicatively connected to a tractor vehicle. A drive slip control signal is received by a tractor vehicle controller and a drive signal is determined depending on the drive slip control signal. The drive signal is emitted to the drive controller for operating the electric drive.

### CROSS-REFERENCE TO RELATED APPLICATIONS

This application is a continuation application of international patent application PCT/EP2024/074396, filed Sep. 2, 2024, designating the United States and claiming priority from German application 10 2023 125 298.4, filed Sep. 19, 2023, and the entire content of both applications is incorporated herein by reference.

### TECHNICAL FIELD

The disclosure relates to a method for a brake controller for operating an electric drive of a trailer vehicle, wherein the trailer vehicle has a drive controller for controlling the electric drive and is configured to be communicatively connected to a tractor vehicle. The disclosure also relates to a computer program and/or computer-readable medium, a brake controller of a trailer vehicle, and a trailer vehicle including an electric drive, a drive controller for controlling the drive, and the brake controller, wherein the trailer vehicle is configured to be communicatively connected to a tractor vehicle.

### BACKGROUND

Such a trailer vehicle is known in the prior art. Trailer vehicles with an electrically drivable drive train are the focus of technical developments. The electrically drivable drive train of the trailer vehicle can be used to improve the traction potential of a multi-unit vehicle, in particular a commercial vehicle, including the trailer vehicle. For example, the trailer vehicle can provide traction when the multi-unit vehicle is stuck and/or driving on a slippery surface.

If the trailer vehicle or its electric drive is operated independently of the trailer vehicle (so-called “eTrailer-only” strategy), the trailer vehicle itself must decide when the electric drive may be operated for starting assistance purposes. Unintended and/or inappropriate driving could lead to dangerous situations such as buckling of the vehicle combination.

Starting assistance functions are state of the art in the field of air suspension. With such a starting assistance function on a semi-trailer, the axles at the rear of the axle assembly are lowered and the axles at the front are raised. This shifts the load to the drive axle of the tractor vehicle and increases the traction potential of the truck-trailer combination.

Patent application DE 10 2023 113 656.9, which had not yet been published on the filing date of the present disclosure, describes a method for operating a lift axle of a tractor-trailer combination with a tractor vehicle and a trailer vehicle, wherein the method includes: detecting a status signal of a traction control system of the tractor vehicle; detecting a speed of the tractor-trailer combination; detecting a change in speed of the trailer vehicle; and outputting an activation signal for operating the lift axle, taking into account the status signal, a threshold value condition relating to the speed, and the change in speed of the trailer vehicle.

DE 10 2019 124 651 A1 discloses a starting aid device for an air-suspended tractor-trailer combination, with an electronically controlled or controllable level control system, which has valve means, sensor means, and control means for variably adjusting a level of a vehicle body and for variably adjusting the axle load acting on the vehicle axles of the tractor-trailer combination via pneumatically pressure-adjustable air spring bellows and/or lift bellows arranged between the vehicle body and the vehicle axles, wherein the trailer vehicle has at least one driven air-suspended vehicle axle and at least one non-driven air-suspended vehicle axle. Accordingly, it is provided that the valve means, sensor means, and control means of the level control system are installed and/or functionally arranged in such a way that the axle load acting on the at least one driven air-suspended vehicle axle and the axle load acting on the at least one non-driven air-suspended vehicle axle of the trailer vehicle can be adjusted differently from each other via controlling at least one of the air suspension bellows in order to improve traction during a starting process.

If the vehicle combination consisting of a trailer vehicle and tractor vehicle is on slippery ground and/or rough terrain, for example, it may be advisable to use the traction potential of the trailer's drive axle as an alternative or in addition to the tractor vehicle's drive axle.

If specially adapted communication between the tractor vehicle and the trailer vehicle is possible (known as the “integrated eTrailer variant”), corresponding requirements from the driver and/or tractor vehicle can be sent to the trailer vehicle, for example, by evaluating the accelerator pedal position. However, such an integrated eTrailer variant is not typically implemented in a tractor vehicle.

### SUMMARY

It is an object of the disclosure to improve the traction potential of a tractor-trailer combination based on slip.

The aforementioned object is, for example, achieved by methods, computer programs, computer readable mediums, brake controllers, and trailer vehicles according various embodiments of the disclosure.

According to one aspect of the disclosure, a method is provided for a brake controller for operating an electric drive of a trailer vehicle, wherein the trailer vehicle has a drive controller for controlling the electric drive and is configured to be communicatively connected to a tractor vehicle. According to the method, a drive slip control signal is received from a controller on the tractor vehicle and a drive signal is determined as a function of the drive slip control signal. The drive signal is emitted to the drive controller for operating the drive.

Based on communication of the traction slip control signal from the tractor vehicle to the trailer vehicle, the trailer vehicle can decide when it is appropriate and safe to drive for starting assistance purposes. The communication can be standard communication: According to standard ISO 11992-1: 2019-05, “Road vehicles Exchange of digital information via electrical connections between towing vehicles and towed vehicles—Part 1: Bit transmission layer and security layer” from May 2019, the status of a traction control system is transmitted from the trailer vehicle to the tractor vehicle and can be evaluated by the trailer-side brake controller. In accordance with ISO 11992, a connection between, for example, a brake controller on the tractor vehicle and the brake controller on the trailer vehicle may be a point-to-point connection in particular. The connection may be established directly or indirectly via a gateway.

It has been recognized that the traction control signal can indicate that the tractor vehicle is pulling, but the traction potential of the multi-unit vehicle is insufficient to move the multi-unit vehicle. In such a state, assistance from the trailer vehicle can be enabled. To this end, the trailer vehicle receives the traction control signal, which can be used to determine the drive signal: For example, if the traction control of the tractor vehicle is active, the brake controller can transmit the drive signal to the electric drive, which controls or drives a drivable axle accordingly.

It was also recognized that the status of the traction control system of the tractor vehicle must be included in standard communication in accordance with ISO 11992, specifically the EBS11 message. The traction control signal can therefore be read by the brake controller as standard and processed in such a way as to control the electric drive. The traction control signal indicates to the trailer that the traction of the tractor vehicle is insufficient. By definition, the tractor vehicle is therefore “pulling” on the trailer, but the traction is not sufficient to set the truck-trailer combination in motion and/or keep it moving. Since it is practically impossible for the trailer vehicle to push forward in this situation, the procedure can be carried out without any safety risks.

According to various embodiments, the drive signal includes a torque request. It has been recognized that the brake controller can already determine whether and/or how to drive based on the traction control signal and transmit the torque request to the drive controller accordingly. The drive controller then implements the torque request. A comparatively simple drive controller can be used for this purpose.

According to various embodiments, the drive signal includes slip information corresponding to the traction control signal for determining a torque request by the drive controller. It has been recognized that it is possible for the brake controller to optionally forward the traction control signal unchanged as slip information to the drive controller, and for the drive controller to determine whether and/or how to drive, and therefore to determine the torque request from the slip information. Features of the electric drive implemented in the drive controller can be taken into account, for example, absolute and/or temperature-related torque and/or power limits.

According to various embodiments, the method includes determining a service brake status, and determining and/or outputting the drive signal depends on the service brake status. It has been recognized that operating a service brake can interfere with driving by the drive. Therefore, the service brake status can influence the drive signal. For example, output of the drive signal may be unnecessary if the service brake status indicates that braking is currently taking place. The service brake status may be the status of a service brake of the trailer vehicle.

According to various embodiments, the method includes detecting a deactivation signal from the controller on the tractor vehicle, and determining and/or outputting the drive signal depends on the deactivation signal. It has been recognized that driving without the traction control signal may be critical to safety: If the traction control signal from the tractor vehicle is deactivated, the drive torque must be reduced and/or the electric drive must be deactivated.

According to various embodiments, the determination and/or output of the drive signal depends on the speed of the trailer vehicle and/or a curve signal. Based on the speed of the trailer vehicle, it is possible to limit the drive as a starting aid function, for example, to driving from a standstill, for example, by introducing a speed threshold above which the drive as a starting aid function is disabled. The curve signal can be used to detect whether the trailer vehicle and/or the tractor-trailer combination is traveling in a curve. The curve signal can be used to prevent an unwanted increase in the breakover angle, that is, the angle between the trailer vehicle and the tractor vehicle.

According to various embodiments, the method includes determining an activation signal for operating a lift axle of the trailer vehicle, taking into account the traction control signal, and outputting the activation signal. It has been recognized that, in addition to controlling traction, a lift axle can be actuated. The lift axle can be an axle of the tractor vehicle and/or trailer vehicle. Several lift axles can also be activated.

According to various embodiments, a speed of the tractor-trailer combination and/or a speed change of the trailer vehicle is recorded to determine the activation signal. Activation of the lift axle to raise the lift axle, for example to implement the start-up aid, is optionally based not only on the traction control signal, but on the traction control signal in combination with the speed and the change in speed. This allows the number of activations of the lift axle to be significantly reduced; in particular, activation of the lift axle in a potentially unnecessary situation can be avoided. This allows improvements to be made to the automatic lift axle functions. The control of the lift axle functions by the traction control signal of the traction control system does not have to be limited to a start-up assistance function, but can also include other functions to increase maneuverability and/or relieve the drive axle in the partially loaded range.

According to various embodiments, the drive signal defines a drive mode for operating the drive, wherein, according to the drive mode, driving takes place below a speed threshold, driving takes place with increased torque, driving takes place with increased slip, thrust by the tractor vehicle is permitted, and/or a shift strategy is influenced. It has been recognized that it is possible to influence the drive in such a way as to provide a further range of possibilities or drive modes.

According to one further aspect of the disclosure, a computer program and/or a computer-readable medium is provided. The computer program and/or computer-readable medium includes commands which, when the program or the commands is or are executed by a computer, cause the latter to carry out the method described here and/or the steps of the method described here. The computer program and/or computer-readable medium may include commands for performing steps of the method described as optional in order to achieve a corresponding technical effect.

According to a further aspect of the disclosure, a brake controller of a trailer vehicle is provided, wherein the brake controller is configured to carry out the method and/or steps of the method described above. The brake controller may be configured to carry out steps of the method described above as optional and/or to implement optional features of the method in order to achieve a corresponding technical effect.

According to a further aspect of the disclosure, a trailer vehicle is provided, including an electric drive, a drive controller for controlling the drive, and the brake controller described above, wherein the trailer vehicle is configured to be communicatively connected to a tractor vehicle. According to various embodiments, the trailer vehicle and/or the brake controller has one or more of the features described above as optional in order to achieve a related technical effect.

Further advantages and features of the disclosure as well as the technical effects thereof can be found in the FIGS. and the description of the preferred embodiments shown in the FIGS., in which:

### BRIEF DESCRIPTION OF DRAWINGS

The invention will now be described with reference to the drawings wherein:

FIG. 1 shows a schematic illustration of a tractor-trailer combination including a trailer vehicle according to an embodiment of the disclosure;

FIG. 2 shows a schematic illustration of a flow chart of a method according to one embodiment of the disclosure;

FIG. 3 shows a schematic illustration of a flow chart of a method according to one embodiment of the disclosure; and

FIG. 4 shows a schematic illustration of a computer program and/or computer-readable medium according to one aspect of the disclosure.

### DETAILED DESCRIPTION

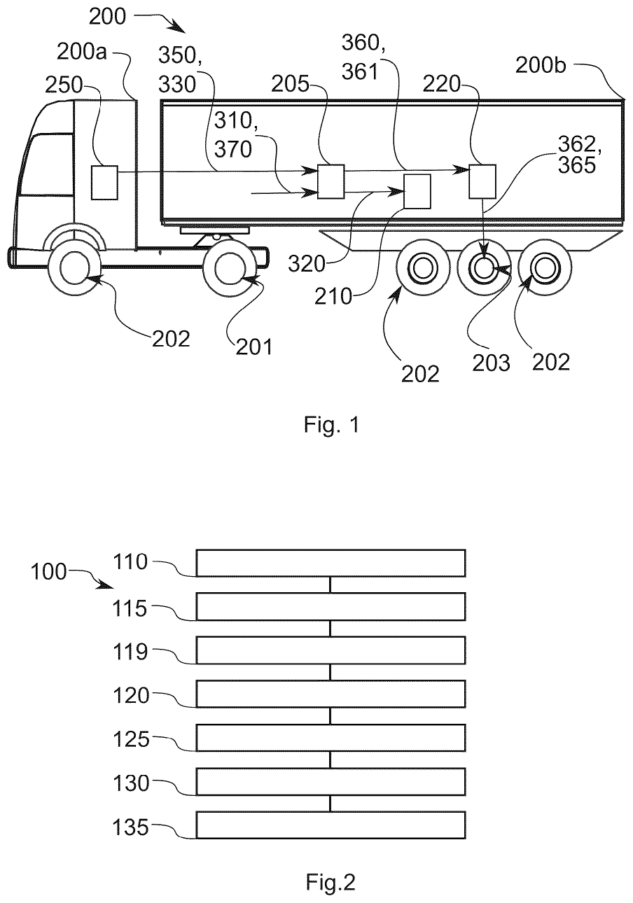

FIG. 1 shows a schematic illustration of a tractor-trailer combination 200 including a trailer vehicle 200b according to an embodiment of the disclosure.

The tractor-trailer combination 200 is a commercial vehicle and a land vehicle. The tractor-trailer combination 200 includes a tractor vehicle 200a and a trailer vehicle 200b. The tractor vehicle 200a and the trailer vehicle 200b are each land vehicles. The trailer vehicle 200b is coupled to the tractor vehicle 200a so that the tractor vehicle 200a can pull, brake, and/or generally move the trailer vehicle 200b.

The tractor vehicle-trailer vehicle combination 200 has a plurality of axles 202. The tractor vehicle 200a has axles 202 and the trailer vehicle 200b has axles 202. At least one axle 205 of the tractor vehicle 200a is a tractor vehicle drive axle 201. In order for the wheels (not shown) of the tractor vehicle drive axle 201 to be driven and/or braked, the tractor vehicle 200a has an electric drive (not shown). To operate the tractor vehicle drive axle 201, the tractor vehicle 200a has a tractor vehicle controller 250 which is configured to perform traction control.

The tractor vehicle controller 250 is configured to control the operation of one or more of the wheels of the tractor vehicle drive axle 201. For this purpose, the tractor vehicle controller 250 is configured to collect and process information relating to driving dynamics. In particular, the tractor vehicle controller 250 is configured to record and/or determine a wheel speed and a vehicle speed in order to determine slip. The tractor vehicle controller 250 is configured to control the operation of the one wheel or the several wheels of the tractor vehicle drive axle 201 on the basis of the slip.

The tractor vehicle controller 250 is configured to transmit a traction control signal 350 to the trailer vehicle 200b when the traction control system intervenes. For this purpose, the trailer vehicle 200b has a brake controller 205. The tractor vehicle controller 250 and the brake controller 205 are connected to each other communicatively, for example via a connection in accordance with ISO 11992. The brake controller 205 is configured to receive and process the traction control signal 350 and, optionally, further messages via the communicative connection.

The trailer vehicle 200b has a trailer-side drive axle 203, a drive 215 for driving the trailer-side drive axle 203, and a drive controller 220 for controlling the drive 215. The drive 215 is, for example, an electric drive that can drive the trailer vehicle 200b by converting electrical energy into mechanical energy or rotational energy of one or more wheels of the trailer-side drive axle 203.

The trailer vehicle 200b has a lift axle 210 (shown only schematically in FIG. 1), that is, an axle 202 configured as a lift axle 210. The lift axle 210 is configured to selectively relieve one or more wheels of the axle 202 configured as a lift axle 210 and/or lift them off the road surface and to load the wheel or wheels and/or lower them onto the road surface. Lifting and/or loading as well as lowering and/or unloading are referred to as the lift axle function. To perform such a lift axle function, the lift axle 210 can be actuated electrically and/or pneumatically. In addition, the trailer vehicle 200b has one or more non-driven axles 206 (not shown), that is, an axle 202 on which no drive torque is transmitted and/or can be transmitted via the drive 215.

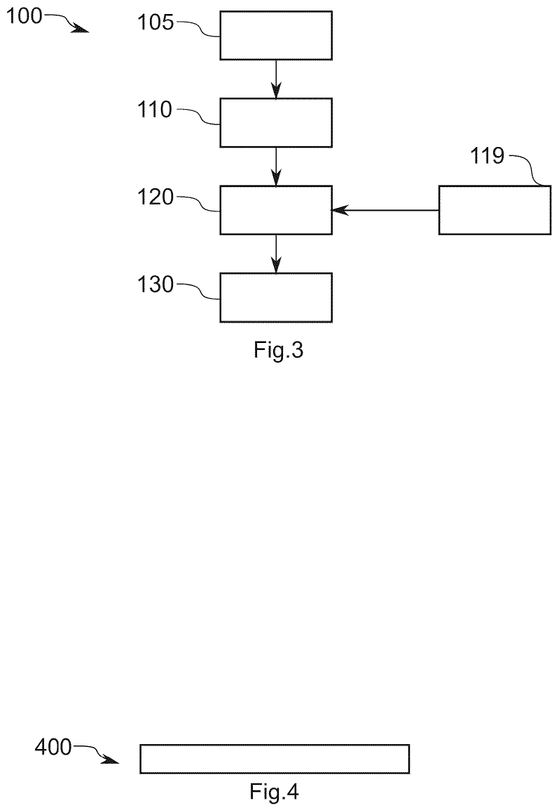

The trailer vehicle 200b and the brake controller 205 are configured to perform the method 100 described in FIGS. 2 and 3, respectively. The operation of the drive 215 can thus be controlled. The operation of the drive 215 is described with reference to FIGS. 2 and 3.

FIG. 2 shows a schematic illustration of flow chart of a method 100 according to one embodiment of the disclosure. The method 100 according to FIG. 2 is a method 100 for a brake controller 205 for operating an electric drive 215 of a trailer vehicle 200b, wherein the trailer vehicle 200b has a drive controller 220 for controlling the electric drive 215 and is configured to be communicatively connected to a tractor vehicle 200a. A trailer vehicle 200b of this kind is described with reference to FIG. 1. FIG. 2 is described with reference to FIG. 1.

The method 100 according to FIG. 2 includes: receiving 110 a traction control signal 350 from a tractor vehicle controller 250. In doing so, the brake controller 205 receives the traction control signal 350 from the tractor vehicle controller 250. The traction control signal 350 is configured to indicate activation of the traction control system.

The method 100 includes: detecting 115 a deactivation signal 330 (see FIG. 1) from the tractor vehicle controller 250. The deactivation signal 330 is configured to indicate deactivation of the traction control system. The deactivation signal 330 is a dedicated signal that describes the deactivation of the traction control system. Alternatively, the deactivation signal 330 may be dispensable if the traction control signal 350 is transmitted during traction control intervention and is absent when traction control is deactivated. In this case, the absence of the traction control signal 350 can indicate the deactivation of the traction control system. The deactivation signal 330 and the traction control signal 350 can be transmitted via the same connection.

The method 100 includes: determining 119 a service brake status 370. The service brake status 370 can be queried from the brake controller 205. The service brake status 370 indicates the state of a trailer vehicle service brake (not shown), that is, whether and/or how the service brake is applied to brake the trailer vehicle 200b. The service brake can be activated by a driver of the tractor-trailer combination 200 and/or by an automated driving function. Alternatively or additionally, the service brake status 370 can be queried via a vehicle bus, for example a CAN bus.

The method 100 includes: determining 120 a drive signal 360 depending on the traction control signal 350. The drive signal 360 is determined or generated when the traction control signal 350 is received and/or indicates intervention by the traction control system. Otherwise, if no traction control signal 350 is received and/or no intervention by the traction control system is indicated, the drive signal 360 is dispensable.

The method 100 includes: determining 125 an activation signal 320 for operating a lift axle 210 of the trailer vehicle 200b, taking into account the traction control signal 350. The lift axle 210 can be activated or actuated in such a way that the traction potential of the trailer vehicle drive axle 203 is increased. For this purpose, the lift axle 210 can be raised and/or lowered.

The method 100 includes: outputting 130 the drive signal 360 to the drive controller 220 for operating the drive 215. The drive signal 360 includes a torque request 362 (see FIG. 1). The electric drive 215 can directly implement the torque request 362. In addition or alternatively, the drive signal 360 includes slip information 361 (see FIG. 1) corresponding to the drive slip control signal 350 for determining a torque request 362 by the drive controller 220. The drive controller 220 can determine the torque request 362 on the basis of the slip information 361 and optionally process information relating to the drive 215.

The determination 120 and/or output 130 of the drive signal 360 depends on the service brake status 370. The drive signal 360 is determined or generated and/or output if the service brake status 370 does not indicate any actuation or braking by the service brake. Otherwise, if the service brake status 370 indicates actuation or braking by the service brake, the drive signal 360 is to be determined and/or output.

The determination 120 and/or output 130 of the drive signal 360 depends on the deactivation signal 330. The determination 120 and/or output 130 of the drive signal 360 may be omitted if the deactivation signal 330 is received from the brake controller 205; in other words, if the anti-slip control is deactivated.

The determination 120 and/or output 130 of the drive signal 360 depends on a speed 310 of the trailer vehicle 200c and/or a curve signal 315. The speed 310 and/or the curve signal 315 can be received for this purpose by CAN message from the tractor vehicle 200a and/or determined via wheel speed sensors.

The drive signal 360 defines a drive mode 365 for operating the drive 215. In accordance with the drive mode 365, driving takes place below a speed threshold, that is, in particular when starting off. Alternatively or additionally, driving is performed with increased torque in order to improve the support of the tractor vehicle 200a by the trailer vehicle 200b. Alternatively or additionally, driving is performed with increased slip. Alternatively or additionally, thrust by the tractor vehicle 200a is permitted during driving and/or a shift strategy is influenced.

The method 100 includes: outputting 135 the activation signal 320 for actuating the lift axle 210. If the traction control system is active, the speed of the tractor-trailer combination 200 is detected and the speed is compared with a threshold value condition relating to the speed. The threshold condition includes a threshold speed. If the speed is less than the threshold speed and/or the speed change of the trailer vehicle 200b is negative, an activation signal 320 is output 135. In other words, for example, the start-up aid is activated at a low speed and/or when stationary in order to operate the lift axle 210. The threshold speed can be, for example, 10 km/h.

FIG. 3 shows a further schematic illustration of flow chart of a method 100 according to one embodiment of the disclosure. FIG. 3 is described with reference to FIGS. 1 and 2.

According to FIG. 3, slip is detected 105 on the tractor vehicle drive axle 201. The tractor vehicle controller 250, for example for an electronic braking system (EBS), accordingly sends the traction control signal 350 (ASR status) to the brake controller 205 (EBS system of the trailer vehicle 200b).

The traction control signal 350 is received 110 from the tractor vehicle controller 250 by the brake controller 205, for example via an ISO 11992 interface.

A drive signal 360 is determined 120 as a function of the traction control signal 350. In this process, a service brake status 370 is determined 119, and the determination 120 of the drive signal 360 depends on the service brake status 370. In other words, a check is performed to determine whether the service brake of the trailer vehicle 200b is active.

The brake controller 205 sends a drive request to the drive controller 220. Accordingly, the drive signal 360 is output 130 from the brake controller 205 to the drive controller 220. The drive controller 220 accordingly sends a torque request 362 to the drive 215, which applies a torque corresponding to the torque request 362.

FIG. 4 shows a schematic illustration of a computer program and/or computer-readable medium 400 according to one aspect of the disclosure. The computer program and/or computer-readable medium 400 includes commands (not shown) which, when the program or the commands is or are executed by a brake controller 205, cause the latter to carry out the method 100 and/or the steps of the method 100 according to FIGS. 2 and/or 3.

The commands may be present as a program code in any code or language, in particular in a code that is suitable for motor vehicle controllers. The computer program and/or computer-readable medium 400 may be or include any digital data storage device, such as a USB stick, a hard disk, a CD-ROM, an SD card, or an SSD card. The computer program does not necessarily have to be stored on such a computer-readable storage medium, but may also be retrievable via the Internet or in some other way.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

100 method
105 detection of slip
110 receiving
115 capturing
119 determining a service brake status
120 determining a drive signal
125 determining an activation signal
130 outputting the drive signal
135 outputting the activation signal
200 tractor-trailer combination, multi-unit vehicle
200a tractor vehicle
200b trailer vehicle
201 tractor vehicle drive axle
202 axle
203 trailer vehicle drive axle
205 brake controller
210 lift axle
215 drive
220 drive controller
250 tractor vehicle controller
310 speed
315 curve signal
320 activation signal
330 deactivation signal
350 traction control signal
360 drive signal
361 slip information
362 torque request
365 drive mode
370 service brake status
400 computer program and/or computer-readable medium

1. A method for a brake controller for operating an electric drive of a trailer vehicle, wherein the trailer vehicle has a drive controller for controlling the electric drive and is configured to be communicatively connected to a tractor vehicle, the method comprising:
receiving a traction control signal from a tractor vehicle controller;
determining a drive signal depending on the traction control signal; and,
outputting the drive signal to the drive controller for operating the electric drive.

2. The method of claim 1, wherein the drive signal includes a torque request.

3. The method of claim 1, wherein the drive signal includes slip information corresponding to a drive slip control signal for determining a torque request by the drive controller.

4. The method of claim 1 further comprising:
determining a service brake status; and,
wherein at least one of said determining the drive signal and said outputting the drive signal depends on the service brake status.

5. The method of claim 1 further comprising:
detecting a deactivation signal from the tractor vehicle controller; and,
wherein at least one of said determining the drive signal and said outputting the drive signal depends on the deactivation signal.

6. The method of claim 1, wherein at least one of said determining the drive signal and said outputting the drive signal depends on a speed of the trailer vehicle and/or a curve signal.

7. The method of claim 1 further comprising:
determining an activation signal for operating a lift axle of the trailer vehicle, taking into account the traction control signal; and,
outputting the activation signal.

8. The method of claim 1, wherein the drive signal defines a drive mode for operating the electric drive, wherein, according to the drive mode at least one of:
driving takes place below a speed threshold;
driving takes place with increased torque;
driving takes place with increased slip;
thrust by the tractor vehicle is permitted; and,
a shift strategy is influenced.

9. A computer program comprising program code which when executed by the brake controller, causes the brake controller to carry out the method of claim 1.

10. A non-transitory computer readable medium comprising commands which when executed by the brake controller, cause the brake controller to carry out the method of claim 1.

11. A brake controller of a trailer vehicle, wherein the trailer vehicle has a drive controller for controlling an electric drive and is configured to be communicatively connected to a tractor vehicle, the brake controller comprising:
a processor;
a non-transitory computer readable storage medium having program code stored thereon;
said program code being configured, when executed by said processor, to:
receive a traction control signal from a tractor vehicle controller;
determine a drive signal depending on the traction control signal; and,
output the drive signal to the drive controller for operating the electric drive.

12. A trailer vehicle comprising:
an electric drive;
a drive controller for controlling said electric drive;
a brake controller including a processor and a non-transitory computer readable storage medium having program code stored thereon;
said program code being configured, when executed by said processor, to:
receive a traction control signal from a tractor vehicle controller;
determine a drive signal depending on the traction control signal;
output the drive signal to the drive controller for operating the electric drive; and,
wherein the trailer vehicle is configured to be communicatively connected to a tractor vehicle.
